(19) United States
(12) Patent Application Publication
(10) Pub. No.: US 2023/0033979 A1
(43) Pub. Date: Feb. 2, 2023

(54) SYSTEMS AND METHODS FOR IDENTIFYING TARGETED DATA

(71) Applicant: OneTrust, LLC, Atlanta, GA (US)

(72) Inventor: Kevin Jones, Atlanta, GA (US)

(73) Assignee: OneTrust, LLC, Atlanta, GA (US)

(21) Appl. No.: 17/877,440

(22) Filed: Jul. 29, 2022

Related U.S. Application Data
(60) Provisional application No. 63/227,809, filed on Jul. 30, 2021.

(51) Int. Cl. G06F 40/289; G06V 30/414; G06F 40/30; G06F 16/35

(52) U.S. Cl. CPC G06F 40/289; G06F 16/353; G06F 40/30; G06V 30/414

(57) ABSTRACT

The present disclosure provides methods, systems, computing devices, computing entities, and/or the like for identifying and/or retrieving targeted data found in unstructured documents. In accordance with various aspects, a method is provided that comprises: receiving, a targeted data request identifying a data subject; processing a first feature representation of each document of a plurality of documents using a classifier machine-learning model to generate a prediction that the document contains the targeted data; generating a dataset that comprises each document having a prediction that satisfy a threshold; processing a second feature representation of each document of the dataset using a clustering machine-learning model to identify a document cluster for the document; and providing the document clusters so that an analysis can be performed on each document cluster to eliminate the document cluster as having targeted data and/or identify the targeted data associated with the data subject found in the document cluster.

### CROSS-REFERENCE TO RELATED APPLICATIONS

This application claims the benefit of U.S. Provisional Pat. Application Serial No. 63/227,809, filed Jul. 30, 2021, which is hereby incorporated herein by reference in its entirety.

### TECHNICAL FIELD

The present disclosure is generally related to digital data processing systems and corresponding data processing methods and products for emulation of intelligence used in identifying targeted data found in electronic materials.

### BACKGROUND

Many entities such as organizations, corporations, companies, and/or the like regularly collect and store large volumes of materials such as documents, records, scripts, reports, and/or the like that is often found in an unstructured format to be used for various purposes. These entities may often wish to mine the materials to identify targeted data found within the unstructured content of the materials collected and stored on the individuals. However, a significant technical challenge lies in the fact that the targeted data is often intermingled with other (e.g., undesired) data within unstructured content of the materials. Conventional hardware and/or software solutions used for identifying types of data contained within materials are typically inadequate, inefficient, and/or inaccurate in distinguishing between targeted data from other data found within the unstructured content of the materials. Therefore, a needs exists in the art for improved systems and methods for identifying targeted data contained within unstructured content of materials.

### SUMMARY

In general, various aspects disclosed below provide methods, apparatuses, systems, computing devices, computing entities, and/or the like for identifying and/or retrieving targeted data found in unstructured documents. In accordance with various aspects, a method is provided that comprises: receiving, by computing hardware, a targeted data request, wherein the targeted data request identifies a data subject and involves a request for targeted data associated with the data subject; processing, by the computing hardware, a first feature representation of each document of a plurality of documents using a classifier machine-learning model to generate a prediction as to a likelihood that the document contains the targeted data, wherein the first feature representation of each document comprises at least one first dimension representing a first feature of unstructured content found in the document; generating, by the computing hardware and based on the prediction for each document of the plurality of documents, a dataset of documents, wherein the dataset of documents comprises each document from the plurality of documents having the prediction satisfy a threshold; processing, by the computing hardware, a second feature representation of each document of the dataset of documents using a clustering machine-learning model to identify a document cluster for the document from a plurality of document clusters, wherein the second feature representation of each document comprises at least one second dimension representing a second feature of the unstructured content found in the document and each document cluster of the plurality of document clusters comprises a subset of similar documents from the dataset of documents; and providing the plurality of document clusters so that an analysis can be performed on each document cluster of the plurality of document clusters to at least one of eliminate the document cluster as having the targeted data associated with the data subject or identify the targeted data associated with the data subject found in the document cluster by reviewing less than all of the subset of similar documents for the document cluster.

In some aspects, the first feature representation comprises a Word2Vec representation, and the second feature representation comprises a term frequency - inverse document frequency (TF-IDF) representation. In some aspects, the method further comprises: identifying, by the computing hardware and based on at least one of a type of the targeted data request or the data subject, a plurality of data sources; and querying, by the computing hardware and based on a parameter provided with the targeted data request, the plurality of data sources to retrieve the plurality of documents. In some aspects, the method further comprises identifying, by the computing hardware, top words found in the subset of similar documents for a particular document cluster of the plurality of document clusters, wherein the top words are also provided along with the plurality of document clusters.

In some aspects, the top words are based on at least one of a top number of words with respect to frequency of appearance in the subset of similar documents for the particular document cluster, a top percentage of words with respect to frequency of appearance in the subset of similar documents for the particular document cluster, or words that satisfy a second threshold with respect to frequency of appearance in the subset of similar documents. In some aspects, the method further comprises: processing, by the computing hardware, features of at least one document of the subset of similar documents for a particular document cluster of the plurality of document clusters using a multi-label machine learning model to generate a second prediction on a likelihood of a certain type of the targeted data is present in the subset of similar documents for the particular document cluster; and determining, by the computing hardware and based on the second prediction satisfying a second threshold, that the certain type of the targeted data is present in the subset of similar documents for the particular document cluster, wherein the certain type of the targeted data is also provided along with the plurality of document clusters.

In some aspects, providing the plurality of document clusters involves providing the plurality of document clusters to a computing system configured to perform the analysis and use the targeted data associated with the data subject to perform an automated task. In some aspects, the automated task comprises at least one of generating a report comprising the targeted data associated with the data subject, creating a map of where the targeted data associated with the data subject is found in the plurality of documents, or deleting the targeted data associated with the data subj ect.

In accordance with various aspects, a system is provided. Accordingly, the system comprises first computing hardware. The first computing hardware is configured to perform operations comprising: receiving a targeted data request that involves targeted data associated with a data subject; processing a first feature representation of each document of a plurality of documents using a classifier machine-learning model to generate a prediction as to a likelihood that the document contains the targeted data, wherein the first feature representation of each document comprises at least one first dimension representing a feature of unstructured content found in the document; generating, based on the prediction for each document of the plurality of documents, a dataset of documents, wherein the dataset of documents comprises each document from the plurality of documents having the prediction satisfy a threshold; processing a second feature representation of each document of the dataset of documents using a clustering machine-learning model to identify a document cluster for the document from a plurality of document clusters, wherein each document cluster of the plurality of document clusters comprises a subset of similar documents from the dataset of documents. In addition, the system comprises second computing hardware. The second computing hardware is communicatively coupled to the first computing hardware and configure to perform operations comprising analyzing the plurality of document clusters to perform an automated task.

In some aspects, the automated task comprises at least one of generating a report comprising the targeted data associated with the data subject, creating a map of where the targeted data associated with the data subject is found in the plurality of documents, or deleting the targeted data associated with the data subject. In some aspects, the classifier machine-learning model also generates a confidence measure for each document of the plurality of documents that identifies a confidence in the prediction generated for the document, and each document in the dataset of documents has the confidence measure satisfy a second threshold. In some aspects, the clustering machine-learning model is selected based on at least one of a type of the targeted data request or a type of the plurality of documents.

In some aspects, the first feature representation comprises a Word2Vec representation, and the second feature representation comprises a term frequency - inverse document frequency (TF-IDF) representation. In some aspects, he first computing hardware is further configured to perform operations comprising: processing features of at least one document of the subset of similar documents for a particular document cluster of the plurality of document clusters using a classifier machine learning model to generate a second prediction on a likelihood of a certain type of the targeted data is present in the subset of similar documents for the particular document cluster; and determining, based on the second prediction satisfying a second threshold, that the certain type of the targeted data is present in the subset of similar documents for the particular document cluster, wherein the certain type of the targeted data is also provided along with the plurality of document clusters.

In accordance with various aspects, a non-transitory computer-readable medium is provided having computing-executable instructions that are stored thereon. The instructions that, when executed by computing hardware, configure the computing hardware to perform operations comprising: receiving a targeted data request that involves targeted data associated with a data subject; processing a first feature representation of each document of a plurality of documents using a classifier machine-learning model to generate a prediction as to a likelihood that the document contains the targeted data, wherein the first feature representation of each document comprises at least one first dimension representing a feature of unstructured content found in the document; generating, based on the prediction for each document of the plurality of documents, a dataset of documents, wherein the dataset of documents comprises each document from the plurality of documents having the prediction satisfy a threshold; and processing a second feature representation of each document of the dataset of documents using a clustering machine-learning model to identify a document cluster for the document from a plurality of document clusters, wherein each document cluster of the plurality of document clusters comprises a subset of similar documents from the dataset of documents, and the plurality of document clusters is provided so that an analysis can be performed on each document cluster of the plurality of document clusters to at least one of eliminate the document cluster as having the targeted data associated with the data subject or identify the targeted data associated with the data subject found in the document cluster by reviewing less than all of the subset of similar documents for the document cluster.

In some aspects, the operations further comprise: identifying, based on at least one of a type of the targeted data request or the data subject, a plurality of data sources; and querying, based on a parameter provided with the targeted data request, the plurality of data sources to retrieve the plurality of documents. In some aspects, the operations further comprise identifying top words found in the subset of similar documents for a particular document cluster of the plurality of document clusters, wherein the top words are also provided along with the plurality of document clusters. In some aspects, the operations further comprise: processing features of at least one document of the subset of similar documents for a particular document cluster of the plurality of document clusters using a multi-label machine learning model to generate a second prediction on a likelihood of a certain type of the targeted data is present in the subset of similar documents for the particular document cluster; and determining, based on the second prediction satisfying a second threshold, that the certain type of the targeted data is present in the subset of similar documents for the particular document cluster, wherein the certain type of the targeted data is also provided along with the plurality of document clusters.

In some aspects, providing the plurality of document clusters involves providing the plurality of document clusters to a computing system configured to perform the analysis and use the targeted data associated with the data subject to perform an automated task. In some aspects, the automated task comprises at least one of generating a report comprising the targeted data associated with the data subject, creating a map of where the targeted data associated with the data subject is found in the plurality of documents, or deleting the targeted data associated with the data subj ect.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for identifying and retrieving targeted data in accordance with various aspects of the present disclosure;

FIG. 2 provides an example of an email containing unstructured content;

FIG. 3 provides another example of an email containing unstructured content;

FIG. 4 provides another example of an email containing unstructured content;

FIG. 5 provides an example of a process for identifying targeted data in accordance with various aspects of the present disclosure; and

FIG. 6 provides an example of document clusters generated in accordance with various aspects of the present disclosure.

FIG. 7 provides an example of an exemplary system architecture that may be used in accordance with various aspects of the present disclosure;

FIG. 8 provides a schematic diagram of a computing entity that may be used in accordance with various aspects of the present disclosure.

### DETAILED DESCRIPTION

### Overview

Many entities such as organizations, corporations, companies, and/or the like regularly collect and store large volumes of materials (e.g., data) such as documents, records, scripts, reports, and/or the like that is often found in an unstructured format to be used for various purposes. For example, many entities regularly collect and store large volumes of data that involve unstructured textual content related to individuals such as social media postings, emails, mobile text messages, transcripts of interactions such as webchats, and/or the like. The entities may collect and store such data, for example, to mine the data to identify relevant information on the individuals such as personnel data on the individuals (e.g., telephone number, home address, etc.), preferences with respect to different product options, media experiences, social views, political options, and/or the like. That is to say, the entities may often wish to mine the data to identify targeted data found within the unstructured content of the data that has been collected and stored on the individuals.

However, a significant technical challenge lies in the fact that the targeted data is often intermingled with other (e.g., undesired) data within unstructured content of the data. Conventional hardware and/or software solutions used for identifying types of data contained within collected and/or stored data are typically inadequate, inefficient, and/or inaccurate in distinguishing between targeted data from other data found within the unstructured content. Such inadequacy, inefficiency, and/or inaccuracy can stem from the fact that targeted data may be contextual and/or in different formats (e.g., standard text, embedded within media, etc.) making it difficult to decipher targeted data from other data. Such inadequacy, inefficiency, and/or inaccuracy can further stem when an entity is interested in identifying targeted data for a particular individual in that the context applicable to the targeted data and/or different formats of the targeted data can make it difficult to conventional software to decipher what targeted data belongs to the individual as opposed to what targeted data belongs to other individuals.

Further technical challenges can arise as the quantity of data (e.g., which may include unstructured content) containing targeted data increases over time, as well as the number of data sources used in storing such materials. Conventional hardware and/or software solutions are typically deficient with respect to identifying and/or retrieving targeted data, especially when attempting to identify and/or retrieve targeted data for a particular individual, which may be spread across a multitude of materials, documents and/or the like and/or found (e.g., stored) in a multitude of data sources. Such deficiencies often result in the fact that conventional hardware and/or software solutions are frequently required to sift through a large amount of data for a single request (e.g., search and retrieval) for targeted data. Again, such deficiencies can further result when a single request for targeted data involves searching and retrieving the targeted data for a particular individual.

Accordingly, various aspects of the present disclosure overcome many of the technical challenges associated with identifying and/or retrieving targeted data that may be found in unstructured content, as well as structured content, of a multitude of documents that may be found over a multitude of data sources. Further, various aspects of the present disclosure overcome many of the technical challenges associated with identifying and/or retrieving targeted data for a particular entity, such as an individual, which may be found in unstructured content. The term “document” is used throughout the remainder of this disclosure. However, various aspects of the disclosure may be applicable to data and other materials that can be considered a “document” such as records, scripts, reports, and/or the like. In addition, the term “data subject” is used throughout the remainder of this disclosure to represent an entity associated with a request for targeted data. For example, a “data subject” may be an individual, organization, association, governmental body, location (e.g., country), brand (e.g., Porsche), object (e.g., Golden Gate Bridge), and/or the like that is associated with a request for targeted data.

Various aspects of the disclosure provide a computational process for identifying and/or retrieving targeted data that can be associated with a particular data subject. In various aspects, an identify targeted data computing system is provided that performs the computational process. In some aspects, the identify targeted data computing system receives a targeted data request that identifies a data subject. In turn, the identify targeted data computing system may retrieve a plurality of documents from one or more data sources. Specifically, the identify targeted data computing system may retrieve a plurality of documents, wherein each document in the plurality of documents includes unstructured content that may potentially contain targeted data associated with the data subject. In various aspects, the identify targeted data computing system processes one or more features of each document using a classifier machine-learning model to generate a prediction as to a likelihood of the document containing the targeted data.

In some aspects, the identify targeted data computing system may initially perform preprocessing on the content (that is unstructured and/or structured) of each of the documents before processing the documents using a classifier machine-learning model. For example, the identify targeted data computing system may perform stemming, lemmatization, text normalization, deduplication, text enrichment, text augmentation, and/or the like. In addition or alternatively, the identify targeted data computing system may generate one or more feature representations of each document by performing, for example, natural language processing on the content (that is unstructured and/or structured ) of each document. The identify targeted data computing system preprocessing the content of each document and/or generating one or more feature representations of each document can place the content of the document in a form that is more conducive for machine learning, especially with respect to unstructured content. This is because the resulting form of the content can provide a structured representation of the content that is otherwise unstructured in its natural state.

In some aspects, the identify targeted data computing system can process a feature representation of each document using the classifier machine-learning model to generate a prediction (e.g., a prediction value) providing a likelihood of the document containing the targeted data. The identify targeted data computing system can then generate a dataset of documents from the plurality of documents based on the prediction generated for each document. For example, the identify targeted data computing system can identify the subset of documents to include those documents from the plurality of documents that have a prediction that satisfies a threshold. In doing so, the identify targeted data computing system can address the technical challenge of having to process a significant number of the plurality of documents to identify the targeted data associated with the data subject contained within the plurality of documents. That is to say, the identify targeted data computing system can significantly reduce the number of documents found in the plurality of documents that need to be further processed (e.g., analyzed) in identifying the targeted data associated with the data subject contained in the plurality of documents.

In additional or alternative aspects, the identify targeted data computing system processes one or more features (e.g., a feature representation) of each document found in the dataset of documents using a clustering machine-learning model to identify a document cluster for the document having documents with similar features from a plurality of document clusters. In some aspects, since the identify targeted data computing system can generate a feature representation of the document that represents features found in the content (in the unstructured and/or structured content) of the document, the identify targeted data computing system can process the feature representation of the document using the clustering machine-learning model to place the document into a document cluster having other documents that have content features in common with the document. In many instances, these common content features can include targeted data and therefore, the identify targeted data computing system’s use of the cluster machine-learning model in processing the feature representation can result in placing the document into a document cluster that contains documents containing common targeted data.

The identify targeted data computing system can provide the plurality of document clusters so that an analysis can be performed on each of the document clusters to, for example, eliminate the document cluster as having targeted data associated with the data subject or identify the targeted data associated with the data subject found in the document cluster by reviewing less than all of the subset of similar documents for the document cluster. As a result, the identify targeted data computing system’s clustering of documents can address the technical challenge encountered by many conventional hardware and/or software applications in having to process (e.g., analyze) a large number (e.g., if not all) of a plurality of documents and other data to locate different targeted data that may be contained in the plurality of documents associated with a data subject. That is to say, the identify targeted data computing system, or some other system, can use the plurality of document clusters to facilitate a more efficient, effective, and timely analysis of the documents to identify targeted data for the data subject found within the documents when compared to conventional hardware and/or software applications used for such purposes.

Further, the identify targeted data computing system can provide further support in conducting the analysis of the plurality of document clusters. In some aspects, the identify targeted data computing system can identify commonalities between features of the subset of documents found in a particular document cluster. For example, the identify targeted data computing system can identify a theme for the subset of documents found in a particular document cluster by identifying the most frequently occurring words in the content of the documents. The identify targeted data computing system, or some other system, can then use the identified theme to focus on certain types of targeted data in performing an analysis on the document cluster.

In additional or alternative aspects, the identify targeted data computing system can further process one or more documents found in a particular document cluster using a classifier machine-learning model to identify (predict) what types of personal data may likely be present in the content of the subset of documents found in the document cluster. For example, the classifier machine-learning model may be a multi-label classifier model that provides a prediction with respect to different types of targeted data that may be present in the subset of documents found in the document cluster. The identify targeted data computing system, or some other system, can then use the predictions to focus on certain types of targeted data in performing an analysis on the document cluster.

With respect to further technical contributions, the identify targeted data computing system’s use of the various machine-learning model(s) can carry out the processing of requests for targeted data in a timely and efficient manner, especially when carrying out such processing on a large volume of documents containing unstructured content. This can be especially advantageous when processing requests for targeted data must be carried out within a relatively short timeframe. Further, the identify targeted data computing system can reduce the computational load needed in processing requests for targeted data. Accordingly, various aspects of the present disclosure make major technical contributions to improving the computational efficiency and reliability of various computing systems and/or processes used for processing requests for targeted data. This in turn translates to enhancing the speed and effectiveness of various computing systems used in processing requests for targeted data and makes important contributions to the various computational tasks that utilize real-time/expedited processing of requests for targeted data. Further detail is now provided on various aspects of the disclosure.

### Example Computing Environment

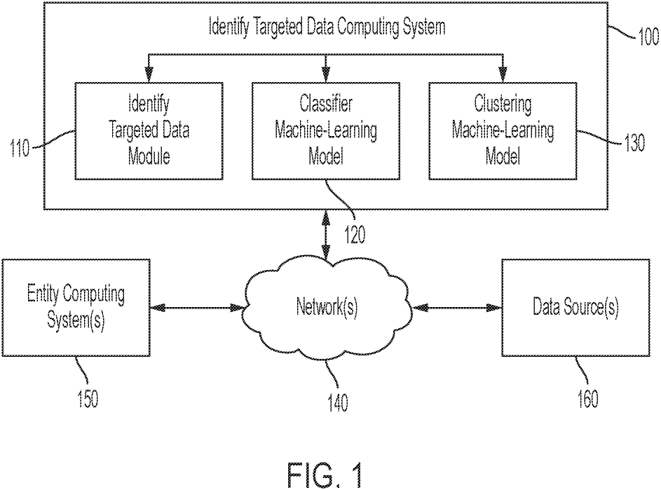

FIG. 1 depicts an example of a computing environment that can be used for identifying and/or retrieving targeted data that can be found in a multitude of documents that may contain unstructured content according to various aspects. An identify targeted data computing system 100 may be provided that includes software components and/or hardware components for identifying and/or retrieving the targeted data that can be found in the multitude of documents. In some aspects, the identify targeted data computing system 100 may provide an identify targeted data service that is accessible over one or more networks 140 (e.g., the Internet) by an entity (e.g., a computing system 150 associated with the entity).

Here, personnel of an entity may wish to identify and/or retrieve targeted data associated with a particular data subject that may be present in a multitude of documents found (e.g., stored) on one or more data sources 160. The personnel, via an entity computing system 150, may access the service over the one or more networks 140 through one or more graphical user interfaces (e.g., webpages) and use the service in identifying and/or retrieving the targeted data associated with the data subject. Accordingly, the identify targeted data computing system 100 may access the one or more data sources 160 over the one or more networks 140 to access and/or retrieve the multitude of documents. In this respect, the identify targeted data computing system 100 may include one or more interfaces (e.g., application programming interfaces (APIs)) for communicating and/or accessing the one or more data sources 160 over the network(s) 140.

In various aspects, the identify targeted data computing system 100 executes an identify targeted data module 110 to identify those documents found in the multitude of documents stored across the one or more data sources 160 that may contain targeted data associated with the data subject. In performing this process, the identify targeted data module 110 may use one or more classifier machine-learning models 120 and/or one or more clustering machine-learning models 130. Further detail is provided below regarding the configuration and functionality of the identify targeted data module 110, classifier machine-learning model(s) 120, and clustering machine-learning model(s) 130 according to various aspects of the disclosure.

### Example Scenario

An example of a real-world scenario is now provided and used herein to assist the reader’s understanding of various aspects of the disclosure. Accordingly, the example is provided to assist in the reader’s understanding of various aspects and should not be construed as limiting the scope of the disclosure. Turning to the particular example, the identify targeted data computing system 100 may receive a request from an entity, such as an organization, which collects and stores targeted data in the form of personal data of individuals. Here, the request may involve a data subject access request (DSAR) associated with a particular individual (data subject) that has been received by the entity and is requesting a copy of personal data (targeted data) stored by the entity that is associated with the individual. The DSAR may include one or more parameters for the particular data subject such as the particular data subject’s first name, last name, email address, and/or the like.

The targeted data for the data subject may be present in various documents containing unstructured content that are found (e.g., stored) over separate data sources 160. For example, the targeted data may be found in various emails processed (e.g., sent and/or received) by the entity and stored on various email servers. Accordingly, emails often contain unstructured content in the sense that the content and configuration of the emails can vary greatly across a particular set of emails.

Emails may be sent for business reasons and/or personal reasons, and may involve any number of senders and/or recipients. Emails may represent communications that a recipient wants to necessarily receive, such as emails from a business client, or communications that the recipient does not necessarily want to receive, such as spam. Accordingly, the content of emails may include various targeted data (e.g., personal data) such as an individual’s social security number, home address, telephone number, and/or the like. In addition, features, components, attributes, and/or the like of the emails may have targeted data such as email addresses in the “to,” “from,” and “cc” fields. Further, emails may be involved in a thread representing an exchange of multiple emails between entities that are related to a particular topic, purpose, subject matter, and/or the like.

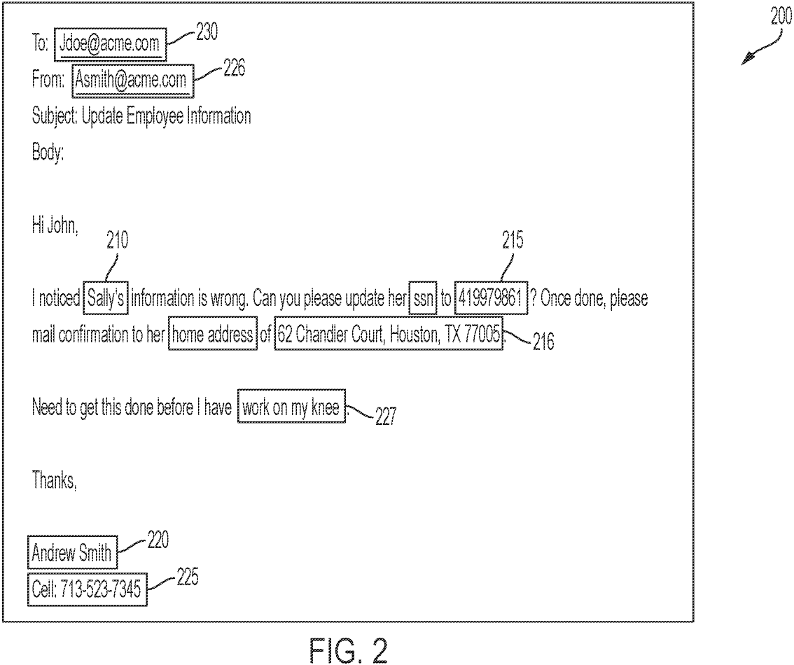

Turning to FIGS. 2, 3, and 4, examples of emails are provided to help demonstrate the challenge in identifying and/or retrieving targeted data, in this instance in the form of personal data, from the emails. Turning first to FIG. 2, this particular example represents an email 200 having personal data for multiple (three) individuals. The first individual mentioned in the body of the email 200 is Sally 210. Here, the content of the email 200 provides Sally’s social security number 215 and home address 216, both of which are considered personal data. In addition, the email 200 provides personal data for Andrew 220, specifically his cell phone number 225, email address 226, and reference to a medical procedure involving his knee 227. Further, the email 200 provides personal data in the form of an email address 230 for the recipient of the email. Thus, the difficulty in identifying and/or retrieving targeted data for one of the individuals associated with the email (e.g., Sally 210) by computer software lies, at least in part, in distinguishing that individual’s targeted data from the other individuals’ targeted data (Andrew’s targeted data) found in the email 200, especially with respect to the unstructured content of the email 200.

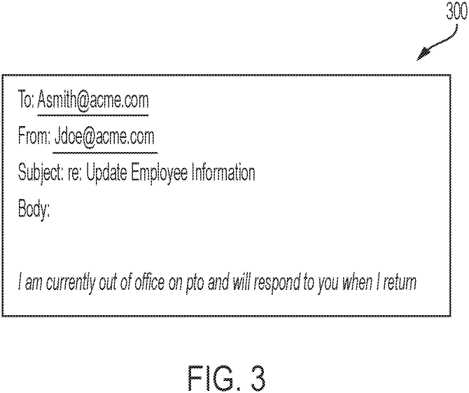

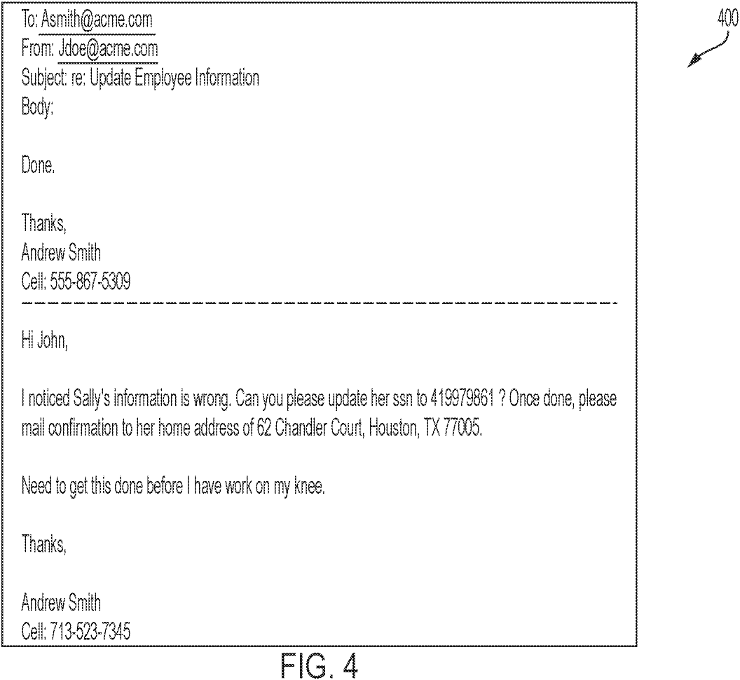

Another difficulty that is often encountered is the sifting through a large number of emails required to identify and/or retrieve targeted data for a particular data subject in which most of the emails are not likely to contain any targeted data and/or in which the various emails contain repeated targeted data already discovered. For instance, FIG. 3 provides an example of an email 300 that is an automated response (e.g., out-of-office response) sent to a received email. Although this email 300 includes personal data in the form of email addresses, the email 300 is not likely to include personal data that is to be included in a response to a request for personal data. Similarly, FIG. 4 provides an example of an email 400 that makes up a part of a thread of emails and represents a very brief follow-on email to an original email and therefore, is not likely to contain additional targeted data beyond what was included in the original email.

These three examples of emails 200, 300, 400 shown in FIGS. 2, 3, and 4 demonstrate some of the difficulties that conventional computer software encounters in identifying and/or retrieving targeted data for a particular data subject from a multitude of documents having unstructured content. The difficulties lie not only in distinguishing targeted data for the particular data subject found in a document from targeted data found in the document associated with other data subjects, but also lie in the fact that the software must make such distinctions, in many instances, over multiple documents found in a large volume of documents containing unstructured content. Accordingly, as discussed further herein, various aspects of the current disclosure can address these difficulties.

### Identify Targeted Data Module

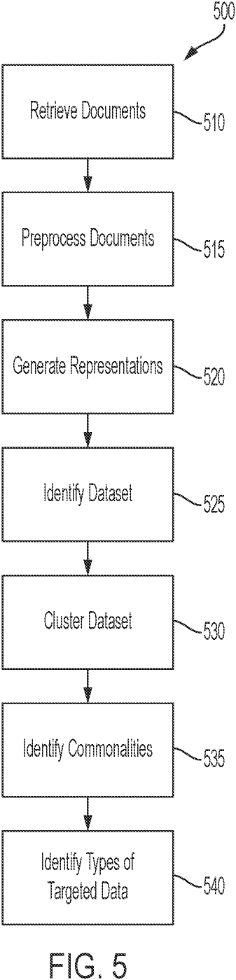

Turning now to FIG. 5, additional details are provided regarding an identify targeted data module 110 used for identifying targeted data that may be present in a plurality of documents in accordance with various aspects. Accordingly, the flow diagram shown in FIG. 5 may correspond to operations executed, for example, by computing hardware found in the identify targeted data computing system 100 as described herein, as the computing hardware executes the identify targeted data module 110.

The process flow 500 involves the identify targeted data module 110 retrieving a plurality of documents that may contain targeted data for the data subject from one or more data sources 160 in Operation 510. In various aspects, the identify targeted data module 110 can perform some type of query on the data source(s) 160 to retrieve the documents that may contain the targeted data for the data subject. In some aspects, the query may be based on one or more parameters and/or attributes such as, for example, one or more parameters provided in the targeted data request that can be used to identify the data subject. For example, the DSAR received by the entity in the above-discussed example may provide one or more data subject parameters such as the data subject’s first name, last name, and/or email address. Accordingly, the identify targeted data module 110 can use one or more of these data subject parameters as parameters and/or attributes in the query.

In addition, the identify targeted data module 110 may query the one or more data sources 160 based on the targeted data request, such as the type of request received, and/or the data subject associated with the request. In the example, the identify targeted data module 110 may identify the one or more data sources 160 as those email servers that are known to be used in storing emails that may be related to the data subject. For example, the data subject may be an employee of the entity that received the targeted data request and therefore, the identify targeted data module 110 may query the email servers that store emails sent or received by the employee, as well as emails sent and received by the employee’s supervisor, human resources personnel, and/or the like that may have emails referencing the employee.

In some aspects, the identify targeted data module 110 preprocesses the content (e.g., the unstructured and/or structured content) found in the retrieved documents in Operation 515. The identify targeted data module 110 can perform preprocessing on the content to transform the content found in the documents into a form that is more conducive for machine learning. This can be especially true with respect to the unstructured content found in a document in that the resulting form of the content can provide a structured representation of the unstructured content that can be more easily understood by a machine-learning model.

Accordingly, the identify targeted data module 110 can perform one or more types of preprocessing on the content of each of the documents. For example, a document may contain audio content. In some aspects, the identify targeted data module 110 can process the audio content using speech recognition technology to generate text (e.g., a transcript) from the words spoken in the audio content. In additional or alternative aspects, the identify targeted data module 110 can configure the text found in the content of a document in lowercasing. This can allow for words with different cases to all map to the same fully lower case form (e.g., allow Ireland, IrelanD, IRELAND to map to ireland).

In additional or alternative aspects, the identify targeted data module 110 performs stemming and/or lemmatization on the text found in the content of a document. Stemming involves reducing inflection words to their root form (e.g., real root form or canonical form of the original word) by removing one or more letters from the inflection words. Accordingly, the identify targeted data module 110 may use various algorithms for stemming such as, for example, a Porter stemming algorithm. Lemmatization does not involve removing letters from the words, but instead transforms words to their actual roots. For example, the identify targeted data module 110 can perform lemmatization that involves transforming the word “better” found in a document to the root word “good.” The identify targeted data module 110 can perform lemmatization by using a dictionary and/or rules-based approach to find the root. Stemming and lemmatization can assist machine learning in understanding variations of words. Stemming and lemmatization can also remove words that may contribute to the unstructured format of the content.

In additional or alternative aspects, the identify targeted data module 110 performs stop word removal on a document. Stop words are commonly used words in a language such as, for example, “a,” “the,” “is,” “are,” and/or the like. The identify targeted data module 110 performing stop word removal on a document can allow for processing of the document using machine learning to focus on the most important words within a document, while also reducing the number of features that may need to be considered during the processing. In addition, the identify targeted data module 110 performing stop word removal on a document can reduce the unstructured nature of the content found in the document. In some instances, the identify targeted data module 110 may replace each of the stop words with a dumb character.

In additional or alternative aspects, the identify targeted data module 110 performs text normalization on a document to transform the text found in the content of the document into a canonical form. For example, the identify targeted data module 110 can perform text normalization to transform “goooood” and “gud” into “good.” In addition, the identify targeted data module 1100 can use text normalization to map near identical words to the same word, as well as address “noisy” text that can often be found in informal communications such as emails and text messages. For example, the identify targeted data module 110 can perform noise removal by removing characters, digits, pieces of text, and/or the like that may interfere with processing the document using machine learning.

In additional or alternative aspects, the identify targeted data module 110 performs text enrichment and/or augmentation on a document by augmenting the text of content found in the document with additional information. For example, the identify targeted data module 110 can perform text enrichment and/or augmentation on a document by including information such as semantics, parts of speech, and/or the like. In addition or alternatively, the identify targeted data module 110 can include structured features of a document (e.g., metadata) such as a type of the document, fields associated with the document (e.g., “to” field of an email, file name of the document, etc.), and/or the like. Accordingly, the identify targeted data module 110 can use such additional information as additional features of a document that may help improve the performance of machine learning used in analyzing the document. In addition, the identify targeted data module 110 can use such additional information to provide structure to unstructured content found in the document.

In additional or alternative aspects, the identify targeted data module 110 performs deduplication on the plurality of documents to remove duplicate or redundant documents and/or information from the documents. For example, the identify targeted data module 110 can compare attributes of documents to identify which documents may be duplicates and/or redundant.

In Operation 520, the identify targeted data module 110 performs natural language processing on the documents to generate one or more feature representations of each document. For example, the identify targeted data module 110 can generate one or more numerical representations of each document. Machine learning can often have a hard time understanding text data. Therefore, the identify targeted data module 110 can perform this operation to transform the text found in the content (the unstructured and/or structured content) for each document into something that a machine learning model can understand better than text. In addition, the identify targeted data module 110 can perform this operation to transform the text found in the unstructured content for each document into a more structured format that may be more conducive for performing machine learning.

In various aspects, the identify targeted data module 110 initially performs tokenization on the documents by separating the text found in the content of the documents into smaller units (e.g., words, characters, sub-words, and/or the like) often referred to as tokens. Once the identify targeted data module 110 has separated the text for each document into tokens, the identify targeted data module prepares a vocabulary that includes a set of unique tokens for the documents.

In some aspects, the identify targeted data module 110 may not perform the tokenization. Instead, the identify targeted data computing system 100, or some other system, may perform tokenization on a set of representative documents (e.g., test set of documents) to build the vocabulary prior to the identify targeted data module 110 processing the targeted data request. For example, if the documents being analyzed for any particular targeted data request are similar for each request (e.g., always emails), then the identify targeted data computing system 100, or some other system, may develop the set of unique terms expected to be found in the documents beforehand to help improve the speed of the identify targeted data module 110 processing any particular targeted data request.

The disadvantage of such a configuration can be that tokens (e.g., new words) may be encountered in the documents retrieved for a particular targeted data request that do not exist in the vocabulary. However, the identify targeted data computing system 100, or some other system, can address this concern by building a vocabulary with the top K frequent words found in the representative documents and replacing rare words with an “unknown” token. Therefore, the identify targeted data module 110 can assign the unknown token to any word encountered in a document retrieved for a particular targeted data request that is not in the vocabulary so that a machine-learning model can handle the associated feature found in the representation of the document accordingly.

Once the vocabulary has been generated (or retrieved, accessed, and/or the like if previously generated), the identify targeted data module 110 generates one or more feature representations for each of the documents. In some aspects, the identify targeted data module 110 can generate a feature representation of a document as an embedded representation of the document based on various features of the document such as words found in the text of the content of the document and/or metadata associated with document. For example, the identify targeted data module 110 can base at least some of the features represented in the feature representation on the tokens represented in the vocabulary. Accordingly, the identify targeted data module 110 can generate the feature representation(s) using any number of embedding techniques such as generating a term frequency - inverse document frequency (TF-IDF) representation of the document (as previously described), a Word2Vec representation of the document, and/or the like.

Generally speaking, TF-IDF is a numerical statistic that demonstrates how important a word is to a corpus. The term frequency (TF) of the word is considered a normalized frequency for the word calculated as a ratio of the number of occurrences of the word in a document to the total number of words in the document. The inverse document frequency (IDF) of the word is the log of the ratio of the number of documents in the corpus to the number of documents containing the word. Inverting the document frequency by taking the logarithm assigns a higher weight to rarer terms. In using this technique, the identify targeted data module 110 multiplies these two frequencies together to generate the TF-IDF value (e.g., score) for the word, placing importance on words frequent in a document and rare in the corpus. Therefore, the identify targeted data module 110 can generate a feature representation (e.g., vector) of each document having a plurality of dimensions (placed in a global ordering) with each dimension representing a unique word found in the document and having the corresponding TF-IDF value of the word for the particular document.

Similar to a TD-IDF representation, a Word2Vec representation provides a numerical representation of various features of the document. For example, a Word2Vec representation may be a vector having a plurality of ordered dimensions representing different features of the document with each dimension having a value as a measure of the feature for the dimension. In various aspects, the identify targeted data module 110 can use some type of machine-learning model, such as a neural network, in generating the Word2Vec representation for a document. Once trained, the weights of the neural network are used as the dimensions of the Word2Vec representation for a new document. Here, the identify targeted data module 110 can use a Word2Vec representation to represent embedded features of the content (e.g., words) found in a document that are not necessarily observable by a human that may be useful in performing classification. In some aspects, the identify targeted data module 110 can generate one or more frequency-based and/or prediction-based feature representations of each of the documents.

Once the feature representation(s) of each of the documents has been generated, the identify targeted data module 110 identifies a dataset from the documents for further analysis to fulfill the request for the targeted data in Operation 525. In various aspects, the identify targeted data module 110 filters the documents that have been retrieved to obtain a dataset that represents documents that are likely to contain targeted data. In various aspects, the identify targeted data module 110 performs this particular operation by processing one or more of the feature representations for each of the documents using machine learning. For example, the identify targeted data module 110 may process a Word2Vec representation of each of the documents using machine learning to identify those documents that are likely to contain targeted data. As described further herein, the machine learning used in this particular operation can involve a classifier machine-learning model that classifies (e.g., provides a prediction for) each of the documents as either a document that is likely to contain targeted data and therefore, should be included in the dataset of documents that is further analyzed, or not.

In various aspects, the identify targeted data module 110 assembles the documents found in the dataset into clusters of similar documents (e.g., groupings of similar documents) in Operation 530. In some aspects, the identify targeted data module 110 performs this particular operation by processing one or more of the feature representations for each of the documents using machine learning. For example, the identify targeted data module 110 may process a TD-IDF representation of each of the documents using machine learning to place the document into a document cluster (grouping) of similar documents. As described further herein, the machine learning used in this particular operation can involve a clustering machine-learning model that places each of the documents into a cluster of documents with similarities to each other. For instance, returning to the example involving identifying personal data found in emails for the data subject identified in the DSAR, the identify targeted data module 110 may generate a first cluster containing emails that belong to a thread involving email exchanges between individuals on a particular topic, subject matter, and/or the like. In addition, the identify targeted data module 110 may generate a second cluster containing emails sent as automated responses such as out-of-office responses. Further, the identify targeted data module 110 may generate a third cluster containing emails that are considered spam (unsolicited commercial emails), and so forth.

An objective in various aspects is for the identify targeted data module 110 to cluster (e.g., group) the documents found in the dataset to enable a more efficient, effective, and timely analysis of the documents (over conventional systems and/or processes) to identify and retrieve the targeted data for the particular data subject found in the documents to fulfill the targeted data request. For example, the identify targeted data computing system 100, or some other system, can perform an automated process, or a reviewer can perform a manual process, to review each of the document clusters that more efficiently and/or timely eliminates the second cluster of emails sent as automated responses, as well as the third cluster of emails sent as spam. As a result, the identify targeted data module 110 can facilitate a significant reduction of the volume of emails having content that needs to be specifically reviewed for targeted data associated with the data subject.

Furthermore, the identify targeted data module 110, through clustering the documents found in the dataset, can enable more efficient, effective, and timely analysis of the documents that need to be specifically reviewed to identify and/or retrieve the targeted data to fulfill the request. For example, the first cluster contains the emails that were exchanged in a particular thread of emails. Here, the identify targeted data computing system 100, some other system, or reviewer may need to only analyze a few of the emails found in the first cluster since a substantial number of the emails found in the thread are likely to have no and/or repeated information such as content, email addresses, subject line, and/or the like. Therefore, the identify targeted data computing system 100, some other system, or reviewer can more easily identify and/or retrieve the targeted data for the particular data subject found in the thread of emails than had the emails been simply grouped with a batch of unrelated (dissimilar) emails returned from a query of an email server.

In various aspects, the identify targeted data module 110 performs additional operations to further assist in identifying and/or retrieving the targeted data for the particular data subject found in the various documents of the dataset. In some aspects, the identify targeted data module 110 identifies commonalities between various features of the documents found in each of the clusters in Operation 535. Commonalities can help identify a “theme” of the documents found in a particular cluster, such as the subject matter discussed and/or described in the documents (e.g., the subject matter of a thread of emails). In addition, commonalities can provide an automated process (e.g., the identify targeted data computing system 100, or some other system) and/or a reviewer with a general sense and/or feel of what the documents found in a cluster contain that can help in analyzing the documents to identify and/or retrieve the targeted data found in the documents for the data subject. For example, the identify targeted data computing system 100, some other system, and/or reviewer may be able to identify certain types of targeted data to focus on based on the commonalities. Thus, commonalities can further assist (guide) in analyzing the documents found in a cluster to identify and/or retrieve targeted data found in the documents for the particular data subject.

For example, the identify targeted data module 110 can identify the top words found in the content of the documents of the cluster as the commonalities of the documents (e.g., top number of words, the top percentage of words, words having a count satisfying particular criteria (e.g., meeting and/or exceeding a particular threshold number, and/or the like). Here, the identify targeted data module 110 may use some type of feature representation of the words to identify the top words. For example, the identify targeted data module 110 may use a TF-IDF value (e.g., score) for each of the words found in each of the documents to identify the top words of the cluster. As a specific example, the identify targeted data module 110 may identify the top words for each of the clusters as the words with the highest mean TF-IDF values across each cluster.

In additional or alternative aspects, the identify targeted data module 110 identifies the types of targeted data found in the documents for each of the document clusters in Operation 540. In some aspects, the identify targeted data module 110 performs this particular operation by using machine learning such as a classifier machine-learning model to identify the types of targeted data found within the documents of a document cluster. Accordingly, the identify targeted data module 110 may process all of the documents found in the document cluster or a subset of the documents found in the document cluster in identifying the types of targeted data that may be found in the documents.

For example, the identify targeted data module 110 may process the documents using a multi-label classifier machine-learning model that provides a prediction as to whether certain types of targeted data (e.g., first name, last name, address, email address, social security number, and/or the like) can be found in the documents of the document cluster. Although the multi-label classifier machine-learning model may only identify the present of a type of targeted data, which may or may not necessarily be associated with the particular data subject, the identify targeted data module’s 110 use of the multi-label classifier machine-learning model to identify the present of types of targeted data in the documents can assist the identify targeted data computing system 100, some other system, or a reviewer to more efficiently, effectively, and timely identify and/or retrieve targeted data associated with the particular data subject found in the document cluster.

In additional or alternative aspects, the identify targeted data module 110 may instead predict the types of targeted data that can be found in the documents during Operation 525 that is performed to identify the dataset. Here, the classifier machine-learning model can be configured to predict the types of targeted data present in each of the documents rather than simply classifying each document as either a document likely to contain targeted data or not. If this is the case, then the identify targeted data module 110 in Operation 540 can use the types of targeted data predicted in Operation 525 in identifying the types of targeted data that may be found in each of the clusters.

At this point, the identify targeted data computing system 100, some other system such as the entity computing system 150, reviewer, and/or any combination thereof can use the document clusters in identifying and/or retrieving the targeted data found in the documents for the particular data subject to fulfill the targeted data request. In addition, the identify targeted data computing system 100, some other system, reviewer, and/or any combination thereof can use the document clusters to carry out one or more other processes, functions, tasks, actions, and/or the like. For example, the identify targeted data computing system 100, some other system, reviewer, and/or any combination thereof can use the document clusters in generating a report on the targeted data, mining one or more legacy systems for the targeted data (e.g., to ensure that legacy systems’ handling of the targeted data comply with current laws, regulations, and/or standards), creating one or more maps of where the targeted data is stored, modifying the targeted data (deleting, updating, supplementing, etc.), and/or the like. Accordingly, the identify targeted data computing system 100, some other system, and/or reviewer’s use of the document clusters can facilitate more efficient, effective, and timely performance of these processes, functions, tasks, actions, and/or the like in comparison to conventional practices.

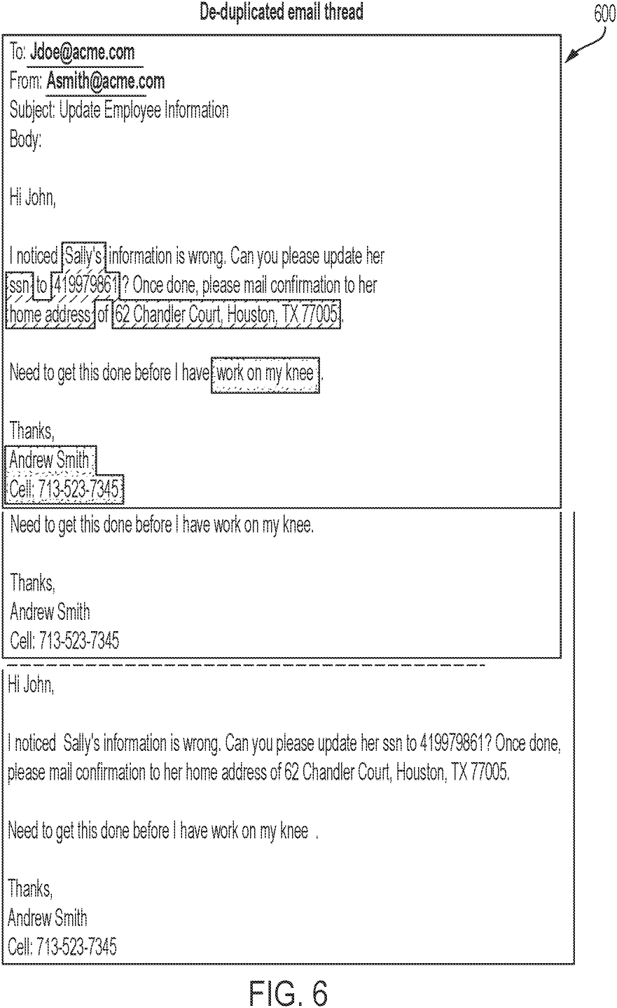

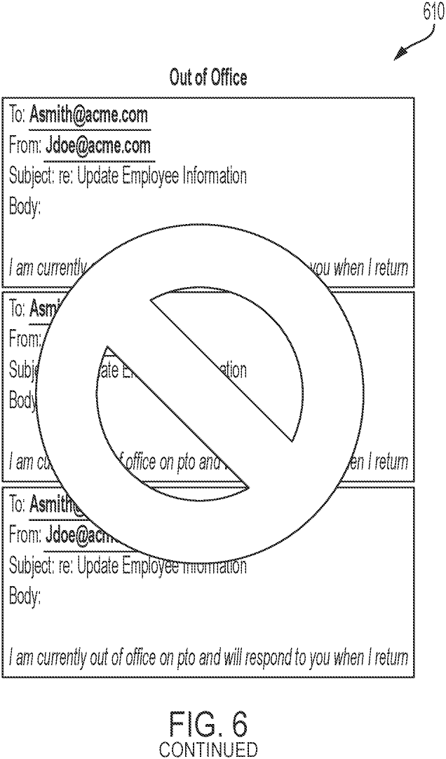

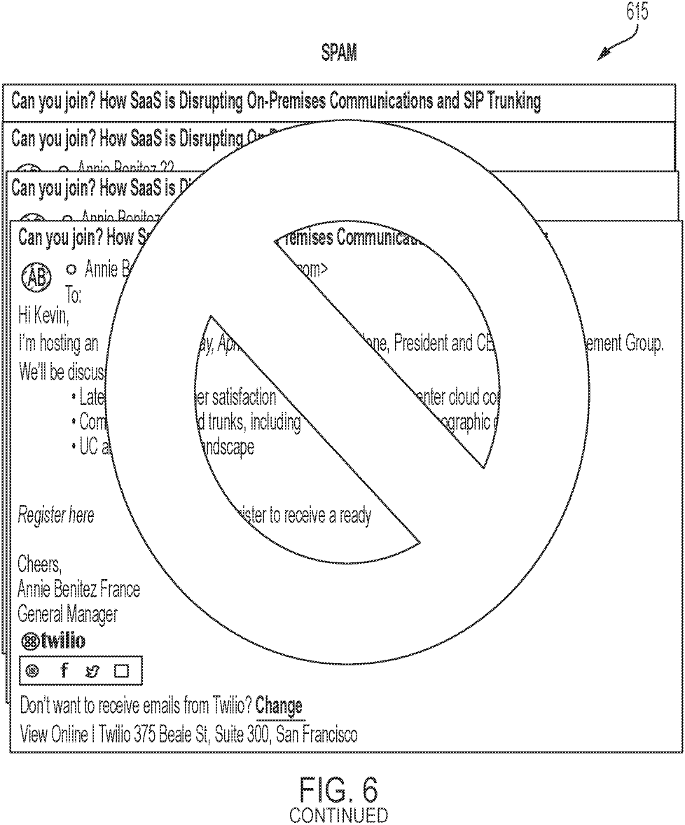

For example, turning to FIG. 6, the identify targeted data module 110 may have generated three document clusters 600, 610, 615 from the documents (e.g., emails) found in the dataset. The first of these document clusters 600 may contain emails associated with a thread and may have targeted data associated with the data subject identified in the targeted data request. The second of these document clusters 610 may contain emails that were sent as auto-responses and, therefore, are unlikely to contain any targeted data needed to fulfill the targeted data request. The third of the document clusters 615 may contain emails that were sent as spam and therefore, are also unlikely to contain any targeted data needed to fulfill the targeted data request. Here, the identify targeted data computing system 100, some other system, and/or reviewer can quickly eliminate the second and third document clusters 610, 615 and as a result, can significantly reduce the scope of emails that need to be analyzed to identify and/or retrieve the targeted data associated with the data subject from the documents.

### Classifier Machine-Learning Model

In various aspects, the classifier machine-learning model is configured for processing one or more feature representations of a document to generate a prediction as to whether or not the document contains targeted data. Accordingly, the classifier machine-learning model can use any one or more of different types of classifiers in generating the prediction such as, for example, a support vector machine, decision tree, logistic regression model, and/or the like. In some aspects, the classifier machine-learning model can include a classifier that generates a prediction for a document on a likelihood that the document contains targeted data. In additional or alternative aspects, the classifier machine-learning model can include one or more classifiers that generate individual predictions on various types of targeted data and the likelihood of the document containing the various types of targeted data (e.g., a multi-label machine-learning model). For example, the classifier machine-learning model may include a first classifier that generates a prediction on a likelihood a document contains an address, a second classifier that generates a prediction on a likelihood the document contains an email address, a third classifier that generates a prediction on a likelihood the document contains a social security number, and so forth.

In some aspects, the classifier machine-learning model can be configured with a classifier hierarchy. The hierarchy can include a first classifier that provides a prediction as to whether a document is likely to contain targeted data. The first classifier can also provide a confidence indicator (e.g., value) along with the prediction. Accordingly, the identify targeted data module 110 can use the prediction to determine whether the document is likely to contain targeted data. For example, the identify targeted data module 110 can determine the document is likely to contain targeted data if the generated prediction (e.g., prediction value) satisfies a threshold (e.g., a threshold value). The identify targeted data module 110 can also use the confidence indicator in determining whether the document is likely to contain targeted data. For example, the identify targeted data module 110 can determine the document is likely to contain targeted data if the generated prediction (e.g., prediction value) satisfies a first threshold (e.g., a first threshold value) and/or the confidence indicator (e.g., the confidence value) satisfies a second threshold (e.g., a second threshold value).

If the identify targeted data module 110 determines the document is likely to contain targeted data, then the identify targeted data module 110 can use the classifier machine-learning model with one or more additional classifiers (e.g., sub-classifiers) to further process the feature representation of the document to generate predictions on the types of targeted data that may be found in the document. Accordingly, the output of the classifier machine-learning module can include separate predictions for each of the types of targeted data that may be found in the document. In addition, the output can include a confidence indicator along with the prediction for each of the sub-classifiers. Similar to the first classifier, the identify targeted data module 110 can determine a document is likely to contain a certain type of targeted data if the prediction (e.g., the prediction value) for the type of targeted data satisfies a first threshold (e.g., a first threshold value) and/or the corresponding confidence indicator (e.g., corresponding confidence value) satisfies a second threshold (e.g., a second threshold value).

In some aspects, the identify targeted data module 110 can use additional context in adjusting, modifying, enhancing, and/or the like a confidence indicator. For example, a date may be found in a document that could simply represent a timestamp or could represent an individual’s birth date, which may be considered targeted data. Here, the document may be an email that was retrieved from an email server used in processing emails for a human resources department of an entity. Therefore, the chance of the date possibly being a birth date may be higher than had the email been retrieved from an email server used in processing emails for the entity’s engineering department. Therefore, the identify targeted data module 110 can enhance the confidence indicator for a sub-classifier providing a prediction of whether the email is likely to contain a targeted date to reflect the source of the email. In some aspects, the identify targeted data module 110 can use classifier profiles configured for each of the sub-classifiers to allow for a custom confidence indicator threshold, context rules for adjusting, modifying, enhancing, and/or the like the confidence indicator, rules on whether the sub-classifier is to be used for a particular document, and/or the like.

In additional or alternative aspects, the classifier machine-learning model can represent separate machine-learning models. For example, the identify targeted data module 110 can use a first classifier machine-learning model in identifying the documents that should be included in the dataset of documents to be analyzed to identify and/or retrieve targeted data to fulfill a particular targeted data request. The identify targeted data module 110 can then use a second, separate classifier machine-learning model comprising classifiers for different types of targeted data at a later time during processing of the targeted data request. For example, the identify targeted data module 110 may use the second classifier machine-learning model after the documents in the subset have been clustered, to identify the types of targeted data that are likely to be found in each of the document clusters. The classifiers for the different types of targeted data can operate in similar fashion to the sub-classifiers discussed above.

Such a configuration can provide higher efficiency in that the identify targeted data module 110 only processes those documents using the second classifier machine-learning model that have been identified as potentially having targeted data. In some aspects, the identify targeted data module 110 can be configured to only process documents using the second classifier machine-learning model that are found in documents clusters identified as requiring further analysis for identifying and/or retrieving targeted data for a particular data subject. Such a configuration can further improve efficiency.

### Clustering Machine-Learning Model

The clustering machine-learning model can be configured for processing a document found in a dataset of documents identified as potentially (e.g., likely) containing targeted data to place the document into a document cluster (e.g., group) containing documents having common/similar features. In various aspects, the clustering machine-learning model is an unsupervised machine-learning model configured to process a set of documents (e.g., a training set of documents) and generate a plurality of document clusters for the set of documents. For example, the clustering machine-learning model can be a k-means clustering model, sequential clustering model, Gaussian mixture model, and/or the like. Here, a feature representation may be used to represent each document in the set of documents that identifies structured and/or unstructured features of the document. The identify targeted data computing system 100 (or some other system) can use these feature representations in training the clustering machine-learning model to generate the plurality of document clusters. Accordingly, each document cluster can represent a subset of the documents found in the dataset of documents that has been clustered together based on the documents placed in the subset having common/similar structured and/or unstructured features.

The feature representations of the documents can include structured and/or unstructured features that represent various characteristics of the documents. For example, the feature representations can include structured and/or unstructured features that represent various metadata, contextual, semantic, content, and/or the like for the documents. In some aspects, the feature representations include structured and/or unstructured features that related specifically to targeted data. In additional or alternative aspects, the feature representations include structured and/or unstructured features related to other types of data that are not necessarily targeted data.

Once trained, the identify targeted data module 110 can use the clustering machine-learning model to identify an inferred document cluster from the plurality of documents clusters for a particular document found in a dataset of documents identified as potentially (e.g., likely) containing targeted data. In some aspects, the clustering machine-learning model is trained prior to receiving a targeted data request. In additional or alternative aspects, the clustering machine-learning model is trained as part of processing the targeted data request. For example, if the dataset of documents for a targeted data request is unique with respect to other targeted data requests that are received, then the identify targeted data computing system 100, or some other computing system, may need to train (or in some instances, tune) the clustering machine-learning model as part of processing the targeted data request so that the model can perform appropriately for the dataset of documents. In some aspects, the identify targeted data computing system 100 may train and use more than one clustering machine-learning model. Here, the identify targeted data module 110 may be configured to select a particular clustering machine-learning model for a particular targeted data request based on, for example, the type of request received and/or the type(s) of documents found in the dataset of documents to be analyzed for the request.

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

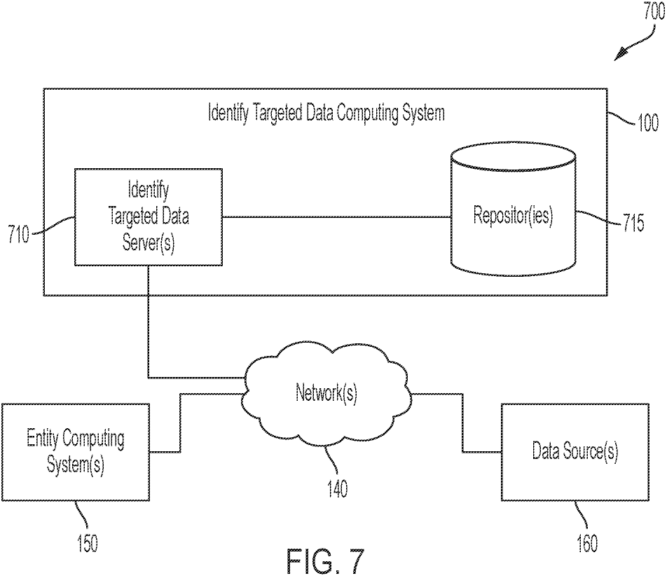

FIG. 7 is a block diagram of a system architecture 700 that can be used in providing the identify targeted data service that is accessible to various entity computing systems 150 according to various aspects as detailed herein. As may be understood from FIG. 7, the system architecture 700 in various aspects includes an identify targeted data computing system 100. The identify targeted data computing system 100 can include various hardware components such as one or more identify targeted data servers 710 and a repository 715. The repository 715 may be made up of one or more computing components such as servers, routers, data storage, networks, and/or the like that can be used to store and manage various documents related to various targeted data requests, as well as one or more machine-learning models that are used in processing the requests.

The identify targeted data computing system 100 can provide the identify targeted data service to the various entity computing systems 150 over one or more networks 140. Here, an entity (e.g., personnel thereof) may access and use the service via an entity computing system 150 associated with the entity. For example, the identify targeted data computing system 100 may provide the service through a website that is accessible to the entity computing system 150 over the one or more networks 140. In addition, the identify targeted data computing system 100 may access one or more data sources 160 over the one or more networks 140 to retrieve documents associated with various targeted data requests.

According, the identify targeted data server(s) 710 may execute an identify targeted data module 110 as described herein. In various aspects, the identify targeted data server(s) 710 can provide one or more graphical user interfaces (e.g., one or more webpages, webform, and/or the like through the website) through which personnel of an entity can interact with the identify targeted data computing system 100. Furthermore, the identify targeted data server(s) 710 can provide one or more interfaces that allow the identify targeted data computing system 100 to communicate with the entity computing system(s) 150 and/or data source(s) such as one or more suitable application programming interfaces (APIs), direct connections, and/or the like.

### Example Computing Hardware

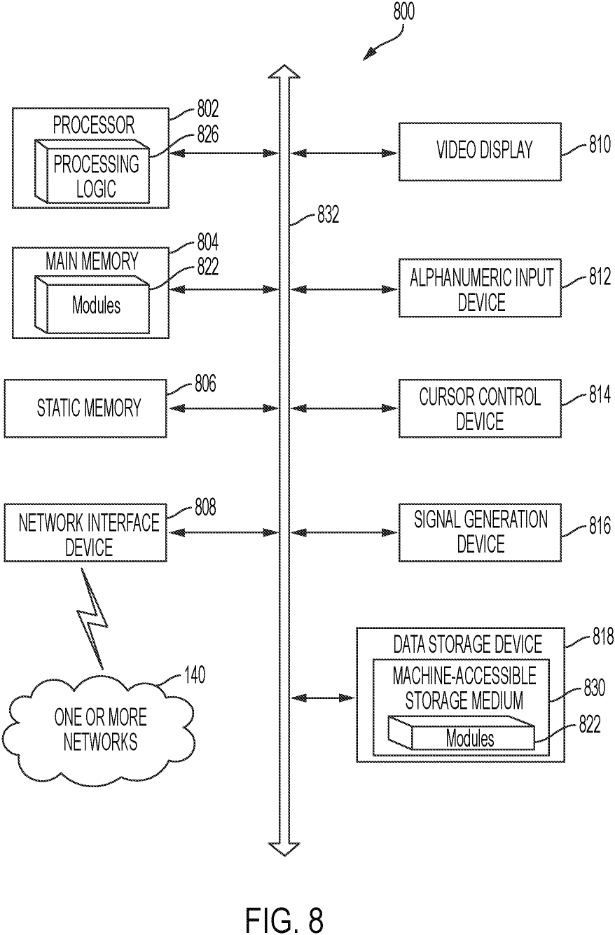

FIG. 8 illustrates a diagrammatic representation of a computing hardware device 800 that may be used in accordance with various aspects. For example, the hardware device 800 may be computing hardware such as an identify targeted data server 710 as described in FIG. 7. According to particular aspects, the hardware device 800 may be connected (e.g., networked) to one or more other computing entities, storage devices, and/or the like via one or more networks such as, for example, a LAN, an intranet, an extranet, and/or the Internet. As noted above, the hardware device 800 may operate in the capacity of a server and/or a client device in a client-server network environment, or as a peer computing device in a peer-to-peer (or distributed) network environment. In some aspects, the hardware device 800 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 800 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 800 includes a processor 802, a main memory 804 (e.g., read-only memory (ROM), flash memory, dynamic random-access memory (DRAM) such as synchronous DRAM (SDRAM), Rambus DRAM (RDRAM), and/or the like), a static memory 806 (e.g., flash memory, static random-access memory (SRAM), and/or the like), and a data storage device 818, that communicate with each other via a bus 832.

The processor 802 may represent one or more general-purpose processing devices such as a microprocessor, a central processing unit, and/or the like. According to some aspects, the processor 802 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 802 may be one or more special-purpose processing devices such as an application specific integrated circuit (ASIC), a field programmable gate array (FPGA), a digital signal processor (DSP), network processor, and/or the like. The processor 802 can execute processing logic 826 for performing various operations and/or steps described herein.

The hardware device 800 may further include a network interface device 808, as well as a video display unit 810 (e.g., a liquid crystal display (LCD), a cathode ray tube (CRT), and/or the like), an alphanumeric input device 812 (e.g., a keyboard), a cursor control device 814 (e.g., a mouse, a trackpad), and/or a signal generation device 816 (e.g., a speaker). The hardware device 800 may further include a data storage device 818. The data storage device 818 may include a non-transitory computer-readable storage medium 830 (also known as a non-transitory computer-readable storage medium or a non-transitory computer-readable medium) on which is stored one or more modules 822 (e.g., sets of software instructions) embodying any one or more of the methodologies or functions described herein. For instance, according to particular aspects, the modules 822 include an identify targeted data module 110 as described herein. The one or more modules 822 may also reside, completely or at least partially, within main memory 804 and/or within the processor 802 during execution thereof by the hardware device 800 - main memory 804 and processor 802 also constituting computer-accessible storage media. The one or more modules 822 may further be transmitted or received over a network 140 via the network interface device 808.

While the computer-readable storage medium 830 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 800 and that causes the hardware device 800 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspects details, these should not be construed as limitations on the scope of any invention or of what may be claimed, but rather as descriptions of features that may be specific to particular aspects of particular inventions. Certain features that are described in this specification in the context of separate aspects may also be implemented in combination in a single aspect. Conversely, various features that are described in the context of a single aspect may also be implemented in multiple aspects separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and it should be understood that the described program components (e.g., modules) and systems may generally be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

1. A method comprising:
receiving, by computing hardware, a targeted data request, wherein the targeted data request identifies a data subject and involves a request for targeted data associated with the data subj ect;
processing, by the computing hardware, a first feature representation of each document of a plurality of documents using a classifier machine-learning model to generate a prediction as to a likelihood that the document contains the targeted data, wherein the first feature representation of each document comprises at least one first dimension representing a first feature of unstructured content found in the document;
generating, by the computing hardware and based on the prediction for each document of the plurality of documents, a dataset of documents, wherein the dataset of documents comprises each document from the plurality of documents having the prediction satisfy a threshold;
processing, by the computing hardware, a second feature representation of each document of the dataset of documents using a clustering machine-learning model to identify a document cluster for the document from a plurality of document clusters, wherein the second feature representation of each document comprises at least one second dimension representing a second feature of the unstructured content found in the document and each document cluster of the plurality of document clusters comprises a subset of similar documents from the dataset of documents; and
providing the plurality of document clusters so that an analysis can be performed on each document cluster of the plurality of document clusters to at least one of eliminate the document cluster as having the targeted data associated with the data subject or identify the targeted data associated with the data subject found in the document cluster by reviewing less than all of the subset of similar documents for the document cluster.

2. The method of claim 1, wherein the first feature representation comprises a Word2Vec representation, and the second feature representation comprises a term frequency - inverse document frequency (TF-IDF) representation.

3. The method of claim 1 further comprising:
identifying, by the computing hardware and based on at least one of a type of the targeted data request or the data subject, a plurality of data sources; and
querying, by the computing hardware and based on a parameter provided with the targeted data request, the plurality of data sources to retrieve the plurality of documents.

4. The method of claim 1 further comprising identifying, by the computing hardware, top words found in the subset of similar documents for a particular document cluster of the plurality of document clusters, wherein the top words are also provided along with the plurality of document clusters.

5. The method of claim 4, wherein the top words are based on at least one of a top number of words with respect to frequency of appearance in the subset of similar documents for the particular document cluster, a top percentage of words with respect to frequency of appearance in the subset of similar documents for the particular document cluster, or words that satisfy a second threshold with respect to frequency of appearance in the subset of similar documents.

6. The method of claim 1 further comprising:
processing, by the computing hardware, features of at least one document of the subset of similar documents for a particular document cluster of the plurality of document clusters using a multi-label machine learning model to generate a second prediction on a likelihood of a certain type of the targeted data is present in the subset of similar documents for the particular document cluster; and
determining, by the computing hardware and based on the second prediction satisfying a second threshold, that the certain type of the targeted data is present in the subset of similar documents for the particular document cluster, wherein the certain type of the targeted data is also provided along with the plurality of document clusters.

7. The method of claim 1, wherein providing the plurality of document clusters involves providing the plurality of document clusters to a computing system configured to perform the analysis and use the targeted data associated with the data subject to perform an automated task.

8. The method of claim 7, wherein the automated task comprises at least one of generating a report comprising the targeted data associated with the data subject, creating a map of where the targeted data associated with the data subject is found in the plurality of documents, or deleting the targeted data associated with the data subject.

9. A system comprising:
first computing hardware configured to perform operations comprising:
receiving a targeted data request that involves targeted data associated with a data subj ect;
processing a first feature representation of each document of a plurality of documents using a classifier machine-learning model to generate a prediction as to a likelihood that the document contains the targeted data, wherein the first feature representation of each document comprises at least one first dimension representing a feature of unstructured content found in the document;
generating, based on the prediction for each document of the plurality of documents, a dataset of documents, wherein the dataset of documents comprises each document from the plurality of documents having the prediction satisfy a threshold;
processing a second feature representation of each document of the dataset of documents using a clustering machine-learning model to identify a document cluster for the document from a plurality of document clusters, wherein each document cluster of the plurality of document clusters comprises a subset of similar documents from the dataset of documents; and
second computing hardware communicatively coupled to the first computing hardware and configure to perform operations comprising analyzing the plurality of document clusters to perform an automated task.

10. The system of claim 9, wherein the automated task comprises at least one of generating a report comprising the targeted data associated with the data subject, creating a map of where the targeted data associated with the data subject is found in the plurality of documents, or deleting the targeted data associated with the data subject.

11. The system of claim 9, wherein the classifier machine-learning model also generates a confidence measure for each document of the plurality of documents that identifies a confidence in the prediction generated for the document, and each document in the dataset of documents has the confidence measure satisfy a second threshold.

12. The system of claim 11, wherein the clustering machine-learning model is selected based on at least one of a type of the targeted data request or a type of the plurality of documents.

13. The system of claim 9, wherein the first feature representation comprises a Word2Vec representation, and the second feature representation comprises a term frequency - inverse document frequency (TF-IDF) representation.

14. The system of claim 9, wherein the first computing hardware is further configured to perform operations comprising:
processing features of at least one document of the subset of similar documents for a particular document cluster of the plurality of document clusters using a classifier machine learning model to generate a second prediction on a likelihood of a certain type of the targeted data is present in the subset of similar documents for the particular document cluster; and
determining, based on the second prediction satisfying a second threshold, that the certain type of the targeted data is present in the subset of similar documents for the particular document cluster, wherein the certain type of the targeted data is also provided along with the plurality of document clusters.

15. A non-transitory computer-readable medium storing computer-executable instructions that, when executed by computing hardware, configure the computing hardware to perform operations comprising:
receiving a targeted data request that involves targeted data associated with a data subj ect;
processing a first feature representation of each document of a plurality of documents using a classifier machine-learning model to generate a prediction as to a likelihood that the document contains the targeted data, wherein the first feature representation of each document comprises at least one first dimension representing a feature of unstructured content found in the document;
generating, based on the prediction for each document of the plurality of documents, a dataset of documents, wherein the dataset of documents comprises each document from the plurality of documents having the prediction satisfy a threshold; and
processing a second feature representation of each document of the dataset of documents using a clustering machine-learning model to identify a document cluster for the document from a plurality of document clusters, wherein each document cluster of the plurality of document clusters comprises a subset of similar documents from the dataset of documents, and the plurality of document clusters is provided so that an analysis can be performed on each document cluster of the plurality of document clusters to at least one of eliminate the document cluster as having the targeted data associated with the data subject or identify the targeted data associated with the data subject found in the document cluster by reviewing less than all of the subset of similar documents for the document cluster.

16. The non-transitory computer-readable medium of claim 15, wherein the operations further comprise:
identifying, based on at least one of a type of the targeted data request or the data subject, a plurality of data sources; and
querying, based on a parameter provided with the targeted data request, the plurality of data sources to retrieve the plurality of documents.

17. The non-transitory computer-readable medium of claim 15, wherein the operations further comprise identifying top words found in the subset of similar documents for a particular document cluster of the plurality of document clusters, wherein the top words are also provided along with the plurality of document clusters.

18. The non-transitory computer-readable medium of claim 15, wherein the operations further comprise:
processing features of at least one document of the subset of similar documents for a particular document cluster of the plurality of document clusters using a multi-label machine learning model to generate a second prediction on a likelihood of a certain type of the targeted data is present in the subset of similar documents for the particular document cluster; and
determining, based on the second prediction satisfying a second threshold, that the certain type of the targeted data is present in the subset of similar documents for the particular document cluster, wherein the certain type of the targeted data is also provided along with the plurality of document clusters.

19. The non-transitory computer-readable medium of claim 15, wherein providing the plurality of document clusters involves providing the plurality of document clusters to a computing system configured to perform the analysis and use the targeted data associated with the data subject to perform an automated task.

20. The non-transitory computer-readable medium of claim 19, wherein the automated task comprises at least one of generating a report comprising the targeted data associated with the data subject, creating a map of where the targeted data associated with the data subject is found in the plurality of documents, or deleting the targeted data associated with the data subject.
